(19) United States
(12) Patent Application Publication
(10) Pub. No.: US 2013/0118176 A1
(43) Pub. Date: May 16, 2013

(54) REGENERATIVE OFFSHORE ENERGY PLANT

(71) Applicant: Robert Bosch GmbH, Stuttgart (DE)

(72) Inventors: Nik Scharmann, Bietigheim-Bissingen (DE); Benjamin Hagemann, Gerlingen (DE)

(73) Assignee: Robert Bosch GmbH, Stuttgart (DE)

(21) Appl. No.: 13/671,604

(22) Filed: Nov. 8, 2012

(30) Foreign Application Priority Data
Nov. 11, 2011 (DE) 10 2011 118 263.6

(51) Int. Cl. F03B 13/18; F03D 11/04; F01B 21/00

(52) U.S. Cl. CPC F03B 13/18; F01B 21/00; F03D 11/04
USPC 60/716; 60/501; 415/4.3

(57) ABSTRACT

An offshore energy plant has a wave energy plant configured to convert energy of a circulating orbital flow of wave motion into mechanical energy of a rotor shaft or crankshaft, for example using the wave harrow principle. The energy plant additionally has at least one wind turbine.

This application claims priority under 35 U.S.C. §119 to patent application no. DE 10 2011 118 263.6, filed on Nov. 11, 2011 in Germany, the disclosure of which is incorporated herein by reference in its entirety.

### BACKGROUND

The disclosure relates to a regenerative offshore energy plant according to the description below.

In the publication “A rotating wing for the generation of energy from waves” by Pinkster et al., published in 2007, a concept is disclosed for a wave energy plant that is used to convert the energy of wave motion. In it, a circulating orbital flow described by water particles in or under the wave is used to flow onto a lifting foil. The lift force of the foil circulating with the orbital flow is converted into rotation of a rotor shaft.

DE 10 2009 035 928 A1 likewise discloses a wave energy plant that is used to convert the energy of a circulating orbital flow. Here a resistance element is carried along by the orbital flow and sets a rotor shaft in rotation.

A disadvantage of such offshore energy plants is the technical complexity of the equipment, for example for anchors on the sea bed or floats and stabilizers and the relatively low energy yield in comparison with the technical complexity of the equipment, in particular when there is a moderate swell.

The object of the disclosure is moreover to provide an offshore energy plant that has an improved energy yield in comparison with the technical complexity of the equipment.

This object is achieved by an offshore energy plant having the features described below.

### SUMMARY

The offshore energy plant according to the disclosure has at least one wave energy plant for converting energy of a circulating orbital flow of wave motion, wherein the energy can be converted at least partially into rotational energy of a rotor rotating about in each case an associated axis of rotation (wave harrow). The energy plant here also has at least one wind turbine. An energy plant is thus provided in which synergies can be exploited by combining two plants that are separately constructed and erected in accordance with the prior art. There is, for example, just one anchor at one location on the sea bed or just one floatation device for the energy plant. The energy or power conversion can also be centralized. The energy yield is thus improved in comparison with the technical complexity of the equipment of the energy plant. When there is variation in when the wind and waves occur, it is possible to equalize the energy conversion with the energy plant according to the disclosure.

Other advantageous embodiments of the disclosure are described below.

A particularly preferred development has at least one generator for converting the energy of the rotor of the wave energy plant and/or of the at least one wind turbine. When just one generator is provided for the whole energy plant, the technical complexity of its equipment is reduced. A gearbox—in particular a summation gearbox—can be connected upstream of the generator or generators. A respective output shaft of the wind turbine can, depending on wind sensors, be coupled to the generator—in particular via a clutch. Alternatively or additionally, the at least one rotor of the wave energy plant can, depending on wind sensors, be coupled to the generator—in particular via a clutch. When a gearbox is provided, the coupling to the generator is effected indirectly via the gearbox.

Configurations of the at least one wave energy plant with and without a rotor shaft are conceivable. In the latter case, coupling bodies of the rotors can be coupled directly to the generator via lever arms. Coupling bodies can be resistance elements and/or buoyancy elements.

The energy plant can be configured so that it floats and can have a mooring (with cables or chains) or it can be anchored to the sea bed, in particular via pylons.

In order to keep the center of gravity of the energy plant as low as possible, it is preferred if the generator—or in particular the wind turbine generator in the case of different generators—is arranged in the vicinity of the still-water line (SWL). In the case of separate generators, in particular the wave energy plant generator is here submerged below the SWL and particularly preferably can be arranged coaxially with the axis of the rotor.

A first alternative of the wind turbine takes the form of a horizontal-axis wind turbine (HAWT) in which the abovementioned output shaft is arranged approximately horizontally. The wind turbine can here have another approximately vertical output shaft that is coupled to the horizontal output shaft via a deflection gear unit—in particular two bevel gears. Such a vertical output shaft enables the torque that occurs to be directed to a generator used together with the wave energy plant. A very efficient development is thereby provided.

It is preferred here if the wind turbine can track the direction of the wind. The efficiency of the wind turbine can thus be maximized in the case of different wind directions.

A second alternative of the wind turbine takes the form of a vertical-axis wind turbine (VAWT) in which the output shaft is arranged approximately vertically. These do not require any deflection or angling of the output shaft and no tracking.

The at least one VAWT can here have a Savonius rotor and/or a Darrieus rotor and/or a Voith Schneider rotor and/or a Gorlov turbine and/or a C rotor and/or a Lenz rotor and/or a Tesla turbine.

The wave energy plant can preferably track the direction in which the waves propagate. The efficiency of the wave energy plant can thus be maximized in the case of different wave directions.

At least one coupling body circulating about the axis of the rotor with the orbital flow is coupled to the rotor of the wave energy plant or plants. It can be at least one resistance element and/or at least one buoyancy element. They can be arranged in such a way that the torque acting on the rotor is maximized. A combination of two buoyancy elements is in particular preferred here. Moreover, the angle of attack of the buoyancy elements can be set depending on the local flow onto the buoyancy elements. Moreover, the rotational speed of the rotor can be set in particular by adapting the generator torque taken off. It has been observed here to be particularly advantageous if a largely constant phase displacement is set between the rotation of the rotor and the orbital flow.

### BRIEF DESCRIPTION OF THE DRAWINGS

Different exemplary embodiments of the disclosure are described below with the aid of the drawings, in which:

FIGS. 1a and lb show a first exemplary embodiment of an offshore energy plant according to the disclosure in two different states;

FIG. 2 shows a second exemplary embodiment of an offshore energy plant according to the disclosure in a schematic view;

FIG. 3 shows a third exemplary embodiment of an offshore energy plant according to the disclosure in a schematic view;

FIG. 4 shows a fourth exemplary embodiment of an offshore energy plant according to the disclosure in a schematic view;

FIG. 5 shows a fifth exemplary embodiment of an offshore energy plant according to the disclosure; and

FIG. 6 shows a sixth exemplary embodiment of an offshore energy plant according to the disclosure.

### DETAILED DESCRIPTION

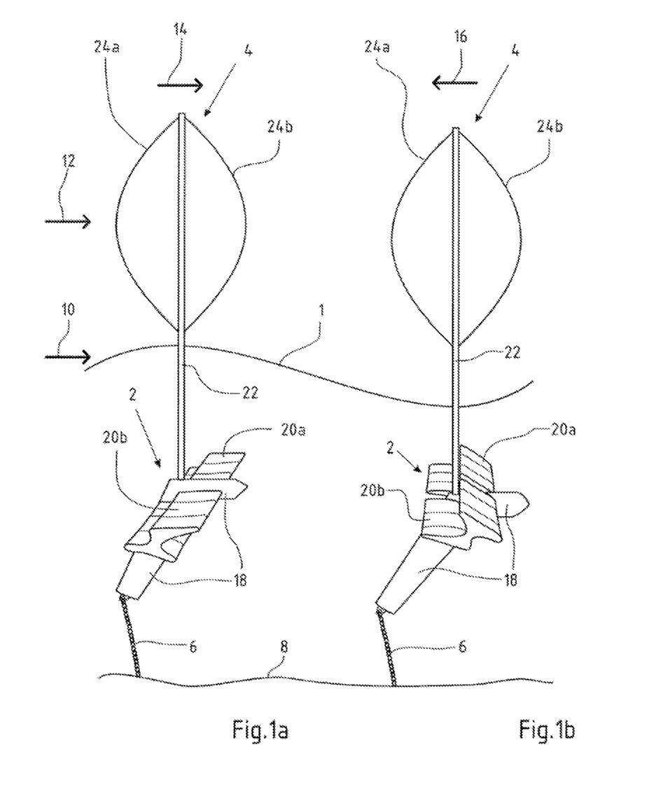

FIGS. 1a and 1b show a first exemplary embodiment of an offshore energy plant according to the disclosure in two different states. Below the wavy water surface 1 of an expanse of sea, the energy plant has a wave energy plant 2, and above the water surface 1 it has a wind turbine 4. The energy plant is configured to float and is anchored to the sea bed 8 via a mooring in the form of a chain 6.

A direction in which the waves propagate 10 and a wave direction 12 (from left to right in FIGS. 1a and 1b, as shown by the arrows) are assumed. A circulating orbital flow is caused by the waves below the water surface 1. Below a wave crest as in FIG. 1a, this results in the flow 14 onto the wave energy plant 2 being in the direction in which the waves propagate 10. Below a wave trough as in FIG. 1b, the circulating orbital flow results in the flow 16 onto the wave energy plant 2 being counter to the direction in which the waves propagate 10.

The energy plant has a casing 18 that is held suspended between the water surface 1 and the sea bed 8 by a buoyancy device (not shown). Moreover, the energy plant can be stabilized in the water via damping plates (not shown).

A side view of the wave energy plant 2 is shown in FIG. 1 and is constantly oriented actively or passively in such a way that two buoyancy rotors 20a, 20b attached to opposite sides of the casing 18 are constantly arranged largely transversely to the direction in which the waves propagate 10. Each buoyancy rotor 20a, 20b has two buoyancy bodies configured as blade foils and the lifting force of which acts as torque about the axis of rotation. In addition, devices (not shown) for adjusting the angle of attack of the blade foils can here be provided in order to optimally orient the latter according to the locally prevailing flow conditions and thus maximize the rotor torque.

The wind turbine 4 is arranged on a top side of the casing 18 and essentially consists of an output shaft 22 that is oriented largely perpendicularly and to the upper part projecting from the water of which at least two curved profiles 24a, 24b are fastened in such a way that they form a Darrieus rotor. According to a first exemplary embodiment, the wind turbine 4 thus forms a vertical-axis wind turbine VAWT that feeds additional rotational energy into the energy plant via its output shaft 22 independently of the wind direction 12.

The rotational energy that occurs simultaneously or with a time delay at the wind turbine 4, on the one hand, and at the two rotors 20a, 20b of the wave energy plant 2, on the other hand, drive at least one generator (not shown) that is arranged in the casing 18 and the electrical energy of which is transmitted to the shore via an electric cable (also not shown). According to the disclosure, it may also be provided that the two buoyancy rotors 20a, 20b shown are securely coupled such that an alternative with a one-piece rotor results in principle.

Clutches can preferably be provided in order to decouple the wind turbine and/or wave energy plant from the at least one generator, should the energy input be correspondingly low.

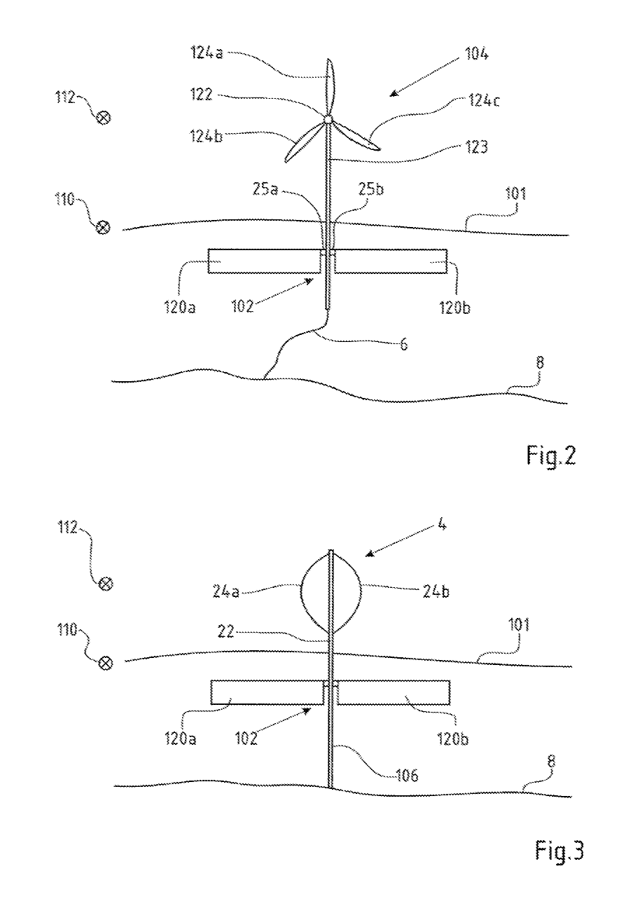

FIG. 2 shows a second exemplary embodiment of an energy plant according to the disclosure in a schematic view. A wave energy plant 102 has two resistance rotors 120a, 120b, while a wind turbine 104 is configured as a horizontal-axis wind turbine (HAWT).

A water surface 101, the average height of which is defined by the still-water line 101 between a wave crest (cf. FIG. 1a) and a wave trough (cf. FIG. 1b), is shown in the second exemplary embodiment. A direction in which the waves propagate 110 and a wave direction 112 are assumed within the plane of the drawing. A front view of the two resistance rotors 120a, 120b is accordingly shown below the water surface.

The wind turbine 104 is configured as a horizontal-axis wind turbine (HAWT). It can have an output shaft 123 accommodated in the approximately perpendicular mast. An approximately horizontally oriented output shaft 122 is provided at the top end portion of the mast and of the output shaft 123. A wind wheel that preferably consists of three rotor blades 124a, 124b, 124c is arranged on the horizontally oriented output shaft 122. The horizontal output shaft 122 can here be coupled to a generator (not shown) via a set of bevel gears (not shown) and via the output shaft 123. As explained with reference to the first exemplary embodiment, the two resistance rotors 120a, 120b of the wave energy plant 2 are likewise coupled to the generator.

FIG. 3 shows a third exemplary embodiment of an energy plant according to the disclosure in a schematic view. Here the wind turbine 4 corresponds to that of the first exemplary embodiment (FIGS. 1a and 1b), while the wave energy plant 102 corresponds to the second exemplary embodiment (FIG. 2). According to the third embodiment, the energy plant is here anchored to the sea bed 8 via a fixed pylon 106.

FIG. 4 shows a fourth exemplary embodiment of an energy plant according to the disclosure in a schematic view. Here the wind turbine 104 of the second exemplary embodiment (cf FIG. 2) is combined with the wave energy plant 102 of the previous exemplary embodiments (cf FIGS. 2 and 3). The energy plant is securely anchored to the sea bed 8 via the pylon 106 of the third exemplary embodiment (cf FIG. 3).

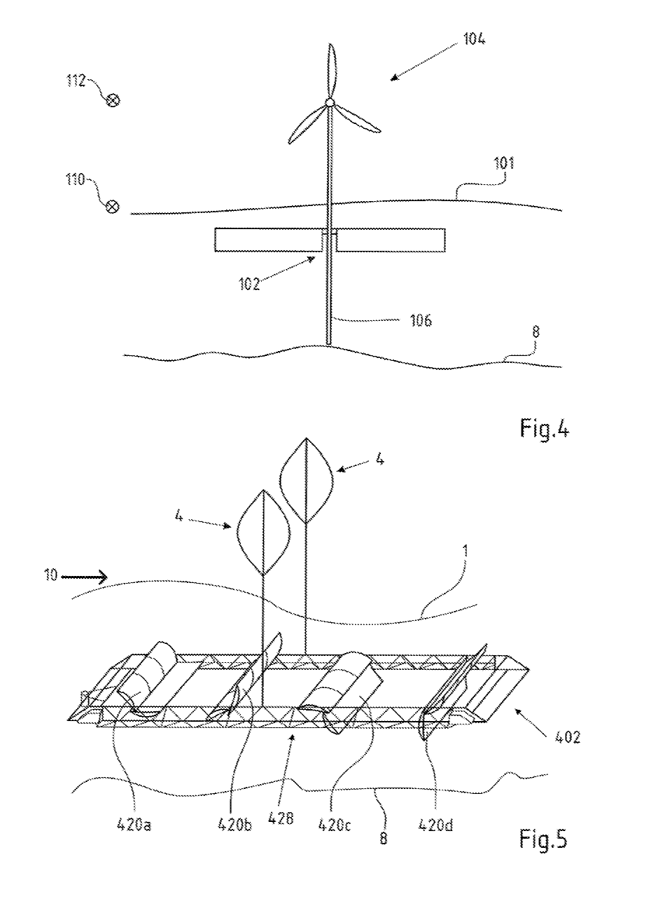

FIG. 5 shows a fifth exemplary embodiment of an energy plant according to the disclosure in a perspective view. Here a frame 428 of a wave energy plant 402 formed from bars and with an essentially rectangular shape is provided that is anchored to the sea bed 8 so that it is approximately horizontal below the water surface 1 via flexible tension means (not shown) (for example in the form of a catenary mooring).

Inside it, the frame 428 carries four rotors 420a, 420b, 420c, 420d that form the essential components of a wave energy plant 402. The frame 428 is oriented with respect to the direction in which the waves propagate 10 in such a way that two longer portions of the frame 428 are oriented essentially in the direction in which the waves propagate 10 and the rotors 420a-d are oriented essentially transversely thereto. The orbital flow that results from the wave motion thus flows onto the four rotors 420a-d and the latter are set in rotation such that a torque acts about the rotor axes. This torque can be converted into electricity at each of the four rotors 420a-d via an individual generator (not shown), but it is also possible to bring the torques together in a common generator by individual means. A wind turbine 4, that in the first exemplary embodiment is configured as a Darrieus rotor that is not dependent on the wind direction, extends in each case upwards from the two longer portions of the frame 428.

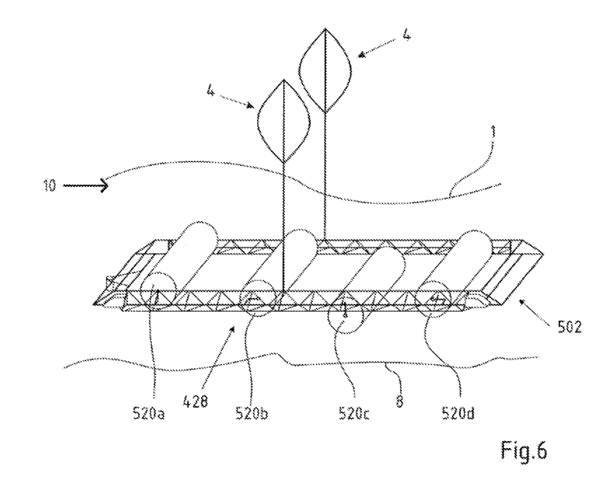

FIG. 6 shows a sixth exemplary embodiment of an energy plant according to the disclosure. It has a wave energy plant 502 with a frame 428 according to the fifth exemplary embodiment (cf FIG. 5). Two wind turbines 4 according to the fifth exemplary embodiment (cf FIG. 5) are attached to the frame 428. In contrast to the fifth exemplary embodiment, the sixth exemplary embodiment has four rotors that are configured as cylindrical resistance rotors 520a, 520b, 520c, 520d and that form the essential components of a wave energy plant 502. The longitudinal axes of the four resistance rotors 520a-520d are arranged via lever arms excentrically with respect to a respective axis of rotation, the lever arms being mounted on both sides in the longer portions of the frame 428. The four resistance rotors 520a-520d are here carried along by the circulating orbital flow that results from the wave motion, following circulating circular paths about the respective axis of rotation.

An offshore energy plant is disclosed that has a wave energy plant for converting energy of a circulating orbital flow of a swell into mechanical energy of at least one rotor, for example using the wave harrow principle. The energy plant here also has at least one wind turbine.

What is claimed is:

1. An offshore energy plant comprising:
at least one wave energy plant configured to at least partially convert energy of a circulating orbital flow of wave motion into rotation of at least one rotor with a rotor axis of the rotor that is oriented largely horizontally; and
at least one wind turbine.

2. The offshore energy plant according to claim 1, further comprising:
at least one generator configured to be coupled to at least one of:
an output shaft of the at least one wind turbine, depending on wind sensors; and
the at least one rotor of the at least one wave energy plant, depending on wind sensors.

3. The offshore energy plant according to claim 1, wherein the off shore energy plant is configured to do one of float with a mooring and be anchored.

4. The offshore energy plant according to claim 2, wherein the at least one generator is arranged in a vicinity of a still-water line.

5. The offshore energy plant according to claims 2, wherein:
the output shaft is arranged approximately horizontally; and
the wind turbine has another approximately vertical output shaft coupled to the approximately horizontal output shaft via a deflection gear unit.

6. The offshore energy plant according to claim 5, wherein the wind turbine is configured to track a wind direction.

7. The offshore energy plant according to claim 2, wherein the output shaft is arranged approximately vertically.

8. The offshore energy plant according to claim 7, wherein the wind turbine has at least one of a Savonius rotor, a Darrieus rotor, a Voith Schneider rotor, a Gorlov turbine, a C rotor, a Lenz rotor, and a Tesla turbine.

9. The offshore energy plant according to claim 1, wherein the wave energy plant is configured to do at least one of passively track a direction of wave propagation and actively track a direction of wave propagation.

10. The offshore energy plant according to claim 1, wherein at least one rotor is a buoyancy rotor with at least one circulating buoyancy element.

11. The offshore energy plant according to claim 1, wherein at least one rotor is a resistance rotor with at least one circulating resistance element.
